(19) United States
(12) Patent Application Publication
(10) Pub. No.: US 2013/0147300 A1
(43) Pub. Date: Jun. 13, 2013

(54) SPINDLE MOTOR

(71) Applicants: Young Sun Yoo, Gyunggi-do (KR); Yeol Choi, Gyunggi-do (KR); Yun Yeong Park, Gyunggi-do (KR)

(72) Inventors: Young Sun Yoo, Gyunggi-do (KR); Yeol Choi, Gyunggi-do (KR); Yun Yeong Park, Gyunggi-do (KR)

(73) Assignee: SAMSUNG ELECTRO-MECHANICS CO., LTD., Gyunggi-do (KR)

(21) Appl. No.: 13/409,978

(22) Filed: Mar. 1, 2012

(30) Foreign Application Priority Data
Dec. 8, 2011 (KR) 1020110130977

(51) Int. Cl. H02K 21/22

(52) U.S. Cl. 310/156.04

(57) ABSTRACT

Disclosed herein is a spindle motor. The spindle motor includes a main magnet formed to have an asymmetrical cross section without a pulling magnet according to the prior art that has been installed on an upper end of a core in order to prevent floating of a rotor, such that the main magnet may prevent the floating of the rotor instead of the pulling magnet.

### CROSS REFERENCE TO RELATED APPLICATION

This application claims the benefit of Korean Patent Application No. 10-2011-0130977, filed on Dec. 8, 2011, entitled “Spindle motor”, which is hereby incorporated by reference in its entirety into this application.

### BACKGROUND OF THE INVENTION

1. Technical Field

The present invention relates to a spindle motor.

2. Description of the Related Art

In a spindle motor, a shaft rotates while maintaining a predetermined contact section with a bearing, such that rotational characteristics may be easily maintained. Therefore, the spindle motor has been widely used as a unit for driving a recording medium requiring high speed rotation, such as a hard disk drive (HDD), an optical disk drive (ODD), or the like.

This spindle motor is configured to include an armature, a rotor including a main magnet generating electromagnetic force between the armature and the main magnet, and a stator rotatably supporting the rotor.

In addition, the rotor may include a clamp, which is a disk fixing device for fixing a disk of the recording medium, and rotates by the electromagnetic force generated between the armature and the main magnet to write data to or reproduce the data from the disk fixed to the clamp.

Meanwhile, the spindle motor may include a pulling magnet in order to prevent the rotor from being floated upwardly due to rotational force generated at the time of driving thereof.

The pulling magnet has been disclosed in detail in Patent Document 1. According to Patent Document 1, the pulling magnet is installed at an upper portion of the armature, thereby preventing an error of the recording medium due to vertical vibration of the rotor.

That is, in a spindle motor according to the prior art including Patent Document 1, the pulling magnet is installed at a lower portion of a rotor case configuring the rotor or on an upper surface of a core configuring the armature to prevent the rotor from being floated due to rotational force generated at the time of driving of the spindle motor, thereby preventing an error of the recording medium from be generated due to vertical vibration.

However, in the case in which the spindle motor is designed to include the pulling magnet, it is difficult to make the entire spindle motor thin. Further, in the case in which a cost of a raw material such as a rare earth element, which is a material of a magnet, increases, the increase in the cost of the raw material should be reflected in a cost of the spindle motor. Therefore, it is difficult to reduce the cost of the spindle motor.

### PRIOR ART DOCUMENT

### Patent Document

(Patent Document 1) KR2009-0058163 A

### SUMMARY OF THE INVENTION

Therefore, the present invention is to solve a problem caused by the use of a pulling magnet installed in order to prevent floating of a rotor in a spindle motor according to the prior art including the above Patent Document 1 by removing the pulling magnet.

The present invention has been made in an effort to provide a spindle motor capable of easily preventing floating of a rotor through a main magnet, being thinned, and easily improving rotational characteristics.

According to a preferred embodiment of the present invention, there is provided a spindle motor including: an armature including a core; a rotor including a main magnet disposed to face the core to thereby generate electromagnetic force; and a stator rotatably supporting the rotor, wherein the main magnet includes an upper layer portion and a lower layer portion formed to have an asymmetrical cross section.

According to another preferred embodiment of the present invention, there is provided a spindle motor including: a shaft; a bearing holder having a bearing provided in an inner portion thereof, the bearing rotatably supporting the shaft; a base plate having the bearing holder installed on an upper portion thereof and provided with a circuit board; a core provided on an outer portion of the bearing holder and having a coil wound therearound; a rotor case installed at an upper portion of the shaft; and a main magnet provided in the rotor case so as to be disposed to face the core and including an upper layer portion and a lower layer portion formed to have an asymmetrical cross section.

The main magnet may have a cross-sectional width narrower in the lower layer portion thereof than in the upper layer portion thereof.

The upper layer portion of the main magnet may be protruded toward the core.

The upper layer portion of the main magnet may be extended so as to be overlapped with an upper end of the core.

The main magnet may have a cross-sectional length shorter in the upper layer portion thereof than in the lower layer portion thereof.

The upper layer portion and the lower layer portion of the main magnet may be formed integrally with each other.

The upper layer portion and the lower layer portion of the main magnet may be formed separately from each other.

The rotor case may include: a fixed part fixed to the shaft; a disk part bent horizontally from a lower end of the fixed part; and a coupling part bent downwardly from the disk part and having the main magnet provided on an inner side thereof.

An inner portion of the bearing holder may be provided with a stopper, and a lower end of the shaft may be provided with a groove part into which the stopper is inserted.

### BRIEF DESCRIPTION OF THE DRAWINGS

FIG. 1 is a cross-sectional view showing a spindle motor according to a preferred embodiment of the present invention;

FIG. 2 is an enlarged cross-sectional view showing a main magnet according to the preferred embodiment of the present invention; and

FIG. 3 is an enlarged cross-sectional view showing the main magnet and a core according to the preferred embodiment of the present invention.

### DESCRIPTION OF THE PREFERRED EMBODIMENTS

The above and other objects, features and advantages of the present invention will be more clearly understood from preferred embodiments and the following detailed description taken in conjunction with the accompanying drawings. In describing the present invention, a detailed description of related known functions or configurations will be omitted so as not to obscure the gist of the present invention.

Hereinafter, a preferred embodiment of the present invention is described hereafter in detail with reference to the accompanying drawings.

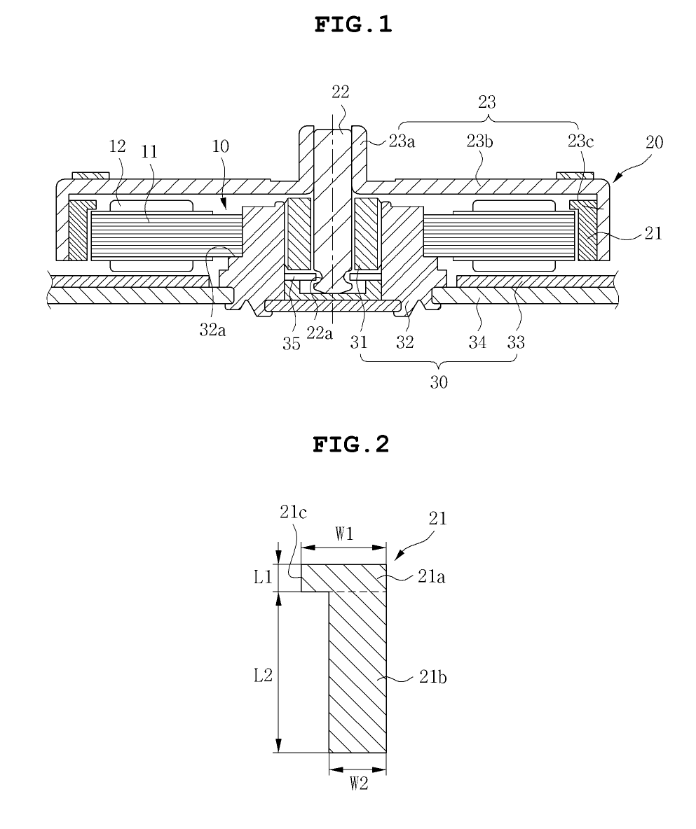

A spindle motor 1 according to a preferred embodiment of the present invention includes an armature 10 including a core, a rotor including a main magnet disposed to face the core 11, and a stator 30 rotatably supporting the rotor 20, as shown in FIGS. 1 to 3.

The main magnet 21 performs a function of generating electromagnetic force between the main magnet 21 and the core 11 to rotate the rotor 20, as known. The main magnet 21 includes an upper layer portion 21a and a lower layer portion 21b formed to have an asymmetrical cross section in order to perform a floating preventing function instead of a pulling magnet as well as the above-mentioned general function.

The lower layer portion 21b performs a function of generating electromagnetic force between the lower layer portion 21b and the core 11 to rotate the rotor 20, which is a general function of the main magnet 21. In addition, the upper layer portion 21a performs a function of generating pulling force to prevent floating of the rotor 20, which is a function of a pulling magnet according to the prior art.

That is, the upper layer portion 21a prevents the floating of the rotor 20 instead of the pulling magnet according to the prior art and prevents magnetic force collision between the pulling magnet and the core 11, thereby making it possible to prevent rotational characteristics of the spindle motor 1 from being deteriorated. Conversely describing this, the pulling magnet is removed, such that the rotational characteristics of the spindle motor 1 may be improved.

The main magnet 21 having the above-mentioned magnetic characteristics is formed as follows. That is, as shown in FIG. 2, the lower layer portion 21b is formed to have a cross-sectional width W2 narrower than a cross-sectional width of the upper layer portion 21a, such that the main magnet 21 is formed to have an asymmetrical cross section.

That is, the lower layer portion 21b is formed to have the cross-sectional width W2 relatively narrower than the cross-sectional width W1 of the upper layer portion 21a, such that the main magnet 21 is formed to have the asymmetrical cross section. Therefore, pulling force is generated while electromagnetic force is generated between the main magnet 21 and the core 11, thereby preventing the floating of the rotor 20.

Here, a part of the upper layer portion 21a protruded as compared to the cross-sectional width W2 of the lower layer portion 21b, that is, a protrusion part 21c is directed toward the core 11, such that the main magnet 21 may be easily provided in the rotor 20.

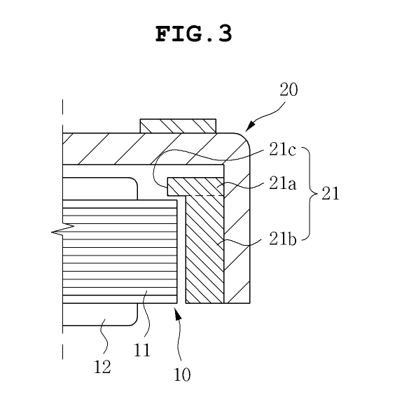

In addition, the protrusion part 21c is overlapped with an upper end of the core 11, that is, an upper end of an edge of the core 11 as shown in FIG. 3, thereby making it possible to prevent the floating of the rotor 20 by pulling force generated between the core 11 and the protrusion part 21c.

That is, the protrusion part 21c is disposed at the upper end of the core 11, such that the pulling force is generated between the protrusion part 21c and the core 11. Here, since the core 11 is provided in the stator 30 and may not move, the main magnet 21 is pulled toward the core 11, thereby preventing the floating of the rotor 20 including the main magnet 21.

Meanwhile, the main magnet 21 is formed so that a cross-sectional length L1 of the upper layer portion 21a is shorter than a cross-sectional length L2 of the lower layer portion 21b, thereby making it possible to make a space between the core 11 and the rotor 20 as narrow as possible. Therefore, thinness of the spindle motor 1 may be promoted.

Here, the cross-sectional length L2 of the lower layer portion 21b compared with that of the upper layer portion 21a corresponds to about the entire length of the generally used main magnet. In addition, the cross-sectional length L1 of the upper layer portion 21a corresponds to about a height of a coil 12 wound around the core 11. Therefore, the space between the core 11 and the rotor 20 may be minimized, such that the thinness of the spindle motor 1 may be promoted.

The upper layer portion 21a and the lower layer portion 21b may be formed integrally with each other. That is, the upper layer portion 21a and the lower layer portion 21b may be formed integrally with each other through injection, or the like, during a process of manufacturing the main magnet 21.

Alternatively, the upper layer portion 21a and the lower layer portion 21b may be formed separately from each other. That is, the upper layer portion 21a and the lower layer portion 21b may be formed separately from each other during the process of manufacturing the main magnet 21 and be then combined with each other through a separate process to thereby be integrated with each other.

Here, the main magnet 21 including the upper layer portion 21a and the lower layer portion 21b so as to have the asymmetrical cross section may be manufactured by a rare earth element used to manufacture a neodymium magnet or be manufactured by ferrite used to manufacture a general magnet (Non ND).

Therefore, when a cost of a raw material such as the rare earth element, or the like, increases, since the main magnet 21 may be manufactured by ferrite, an increase in a cost of the main magnet 21 or an increase in a general manufacturing cost of the spindle motor 10 may be prevented.

Meanwhile, the spindle motor 1 including the main magnet 21 has the following configuration. That is, the spindle motor 1 includes the armature 10 including the core 11, the rotor 20 including the main magnet 21 disposed to face the core 11, and the stator 30 rotatably supporting the rotor 20, as described above.

The stator 30 includes a bearing 31 rotatably supporting a shaft and a bearing holder 32 having the bearing 31 provided in an inner portion thereof, as shown in FIG. 1. In addition, the stator 30 includes a base plate 34 having the bearing holder 32 installed on an upper portion thereof and provided with a circuit board 33 for supplying external power to the armature 10.

The armature 10 includes the core 11 provided on an outer portion of the bearing holder 32. To this end, the bearing holder 32 includes a catching part 32a formed in a step shape on the outer portion thereof. In addition, the core 11 has the coil 12 wound therearound through a pole to generate the electromagnetic force between the core 11 and the main magnet 21, thereby rotating the rotor 20.

The rotor 20 includes the shaft 22 having a lower end rotatably installed in the bearing 31, a rotor case installed at an upper portion of the shaft 22, and the main magnet 21 including the upper layer portion 21a and the lower layer portion 21b formed to have the asymmetrical cross section.

Since the pulling magnet according to the prior art may be removed due to the main magnet 21, the rotor case 23 may include a fixed part 23a fixed to the shaft 22, a disk part 23b bent horizontally from a lower end of the fixed part 23a and having a disk mounted thereon, and a coupling part 23c bent downwardly from the disk part 23b, wherein the coupling part 23c includes the main magnet 21 provided on an inner side thereof.

Since the rotor case 23 having the above-mentioned shape may easily secure a space between the rotor case 23 and the core 11, the spindle motor 1 may be easily thinned. In addition, since a clamp, or the like, for elastically mounting the disk on an upper portion of the disk part 23b may be easily installed, an error generation rate during a process of writing data to or reproducing the data from the disk is reduced.

Therefore, in the spindle motor 1 including the rotor 20, the armature 10, and the stator 30, the external power is supplied to the armature 10 through the circuit board 33, such that the rotor 20 rotates by the electromagnetic force generated between the lower layer portion of the main magnet 21 and the core 11, thereby making it possible to write the data to or reproduce the data from the disk.

In addition, the main magnet 21 pulls the rotor 20 downwardly by the pulling force of the upper layer portion 21a, thereby preventing the rotor 20 from being floated upwardly due to rotational force during the process of writing data to or reproducing the data from the disk.

Meanwhile, in the spindle motor 1, an inner portion of the bearing holder 32, that is, a lower portion of the bearing 31 is provided with a stopper 35, and a lower end of the shaft 22 is provided with a groove part 22a into which the stopper 35 is inserted.

That is, at the time of floating of the shaft 22, the groove part 22a formed at the lower end of the shaft 22 is caught by the stopper 35, thereby making it possible to prevent the floating of the rotor 20 through the stopper 35 together with the main magnet 21.

As set forth above, according to the embodiments of the present invention, even though the pulling magnet is removed, the floating of the rotor may be easily prevented through the main magnet having an asymmetrical cross section, and a space between the armature and the rotor is secured due to the removal of the pulling magnet, thereby making it possible to easily make the spindle motor thin.

In addition, magnetic force collision generated between the pulling magnet and the armature is prevented, thereby making it possible to improve rotational characteristics of the spindle motor, and the number of components is reduced, thereby making it possible to reduce a manufacturing cost.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising:
an armature including a core;
a rotor including a main magnet disposed to face the core to thereby generate electromagnetic force; and
a stator rotatably supporting the rotor,
wherein the main magnet includes an upper layer portion and a lower layer portion formed to have an asymmetrical cross section.

2. The spindle motor as set forth in claim 1, wherein the main magnet has a cross-sectional width narrower in the lower layer portion thereof than in the upper layer portion thereof.

3. A spindle motor comprising:
a shaft;
a bearing holder having a bearing provided in an inner portion thereof, the bearing rotatably supporting the shaft;
a base plate having the bearing holder installed on an upper portion thereof and provided with a circuit board;
a core provided on an outer portion of the bearing holder and having a coil wound therearound;
a rotor case installed at an upper portion of the shaft; and
a main magnet provided in the rotor case so as to be disposed to face the core and including an upper layer portion and a lower layer portion formed to have an asymmetrical cross section.

4. The spindle motor as set forth in claim 3, wherein the main magnet has a cross-sectional width narrower in the lower layer portion thereof than in the upper layer portion thereof.

5. The spindle motor as set forth in claim 4, wherein the upper layer portion of the main magnet is protruded toward the core.

6. The spindle motor as set forth in claim 5, wherein the upper layer portion of the main magnet is extended so as to be overlapped with an upper end of the core.

7. The spindle motor as set forth in claim 6, wherein the main magnet has a cross-sectional length shorter in the upper layer portion thereof than in the lower layer portion thereof.

8. The spindle motor as set forth in claim 7, wherein the upper layer portion and the lower layer portion of the main magnet are formed integrally with each other.

9. The spindle motor as set forth in claim 7, wherein the upper layer portion and the lower layer portion of the main magnet are formed separately from each other.

10. The spindle motor as set forth in claim 3, wherein the rotor case includes:
a fixed part fixed to the shaft;
a disk part bent horizontally from a lower end of the fixed part; and
a coupling part bent downwardly from the disk part and having the main magnet provided on an inner side thereof.

11. The spindle motor as set forth in claim 3, wherein an inner portion of the bearing holder is provided with a stopper, and a lower end of the shaft is provided with a groove part into which the stopper is inserted.
